(19) United States
(12) Patent Application Publication
(10) Pub. No.: US 2022/0024093 A1
(43) Pub. Date: Jan. 27, 2022

(54) INJECTION MOLDING SYSTEM

(71) Applicant: Canon Virginia, Inc., Newport News, VA (US)

(72) Inventor: Koki Kodaira, Tokyo (JP)

(21) Appl. No.: 17/368,170

(22) Filed: Jul. 6, 2021

Related U.S. Application Data
(60) Provisional application No. 63/054,627, filed on Jul. 21, 2020.

(51) Int. Cl. B29C 45/27; B29C 45/50; B29C 45/46

(52) U.S. Cl. CPC B29C 45/2703; B29C 2045/2691; B29C 45/461; B29C 45/50

(57) ABSTRACT

A method for performing injection molding using a mold with at least two cavities and an injection cylinder includes supplying resin to be injected into a first cavity, from among the at least two cavities, of the mold to the injection cylinder, injecting the resin into the first cavity, supplying resin to be injected into a second cavity, from among the at least two cavities, of the mold to the injection cylinder, and injecting the resin into the second cavity, wherein the resin injected into the first cavity is cooled, wherein the resin injected into the second cavity is cooled, and wherein molded parts are removed from the first cavity and from the second cavity after the resin in the first cavity has cooled and solidified and the resin the second cavity has cooled and solidified.

### CROSS-REFERENCE TO RELATED APPLICATION

This application claims the benefit of U.S. Provisional Application 63/054,627, which was filed on Jul. 21, 2020.

### FIELD

The present disclosure relates to an injection molding system.

### BACKGROUND

Japanese Patent No. 3795005 discusses an injection molding method where a mold with a plurality of cavities different in shape and size is used and molding is performed after selecting a cavity. In this injection molding method, injection, dwelling and depressurization are performed a plurality of times during one molding process. The timing of filling resin for each of the plurality of cavities is controlled by a runner opening/closing device provided in a molding tool such that cavities of different shapes are not simultaneously filled.

In the injection molding method of Japanese Patent No. 3795005, injection and dwelling are performed individually for each cavity. The position and speed of forward stopping of an injection screw are controlled based on the individual process of each cavity. The dwelling time is controlled from a filling completion position for each cavity. The injection molding method also includes closing a molten resin path connecting to the cavity at a dwelling completion position, releasing a resin pressure of an injection cylinder and a resin path that connects to the injection cylinder, and controlling an injection screw stop position after the resin pressure is released as the injection process start point so injection filling/dwelling is performed for the next cavity.

In the above-described injection molding method, a plurality of cavities are injected and filled by a one-time resin injection process, i.e., resin material is melted, the injection cylinder filled with the melted resin for all of the cavities, and each of the cavities are then respectively filled. Under this injection molding method, the greater the number of cavities, the longer the molten resin will be stagnate in the injection cylinder.

Engineering plastics, such as nylon, and super engineering plastics are affected by heat generated in the injection cylinder. Their structure tend to break down over a short period of time, which creates a condition where injection molding becomes impossible. In addition, even if injection molding can be performed, the properties often inherent in the resin cannot be exhibited. When molding an engineering plastic or a super engineering plastic using the above-described injection molding method, the resin breaks down in the injection cylinder for the particular cavity being used for the injection molding, which impacts the ability to perform injection molding using others cavities from the plurality of cavities.

The resin properties of the molded part formed in a first cavity and in a last cavity are different due to the impact of the resin stagnation time difference in the injection cylinder. Thus, the original resin properties cannot be exhibited.

What is needed is an injection molding method using a mold with a plurality of cavities with different shapes and sizes, wherein when molding is performed with a preset injection screw speed and injection pressure from filling to dwelling in each of the plurality of cavities, a molded part having stable weight, dimensions and shape can be obtained by incorporating the operation of melting resin material and filling an injection cylinder with the melted resin of each of the plurality of cavities, and at the same time, the molding of a resin easily affected by the heat of a cylinder is enabled.

### SUMMARY

According to an aspect of the present disclosure, a method for performing injection molding using a mold with at least two cavities and an injection cylinder with an injection cylinder includes supplying resin to be injected into a first cavity, from among the at least two cavities, of the mold to the injection cylinder, injecting the resin into the first cavity, supplying resin to be injected into a second cavity, from among the at least two cavities, of the mold to the injection cylinder, and injecting the resin into the second cavity, wherein the resin injected into the first cavity is cooled, wherein the resin injected into the second cavity is cooled, and wherein molded parts are removed from the first cavity and from the second cavity after the resin in the first cavity has cooled and solidified and the resin the second cavity has cooled and solidified.

### BRIEF DESCRIPTION OF THE DRAWINGS

FIG. 1 illustrates and injection molding method using a mold with a plurality of available cavities and an injection unit.

FIG. 2 illustrates a process sequence when injection molding is performed using a control system of the mold and the injection unit illustrated in FIG. 1.

FIG. 3 illustrates an injection molding performed based on the process illustrated in FIG. 2.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF EXEMPLARY EMBODIMENTS

An injection molding method according to an exemplary embodiment of the present disclosure will be described with respect to an injection molding machine and a mold with a plurality of cavities and a resin gate installed in the resin path leading to each cavity. In the following description, the process of melting a predetermined amount of resin material and filling an injection cylinder using an injection screw is referred to as “plasting”.

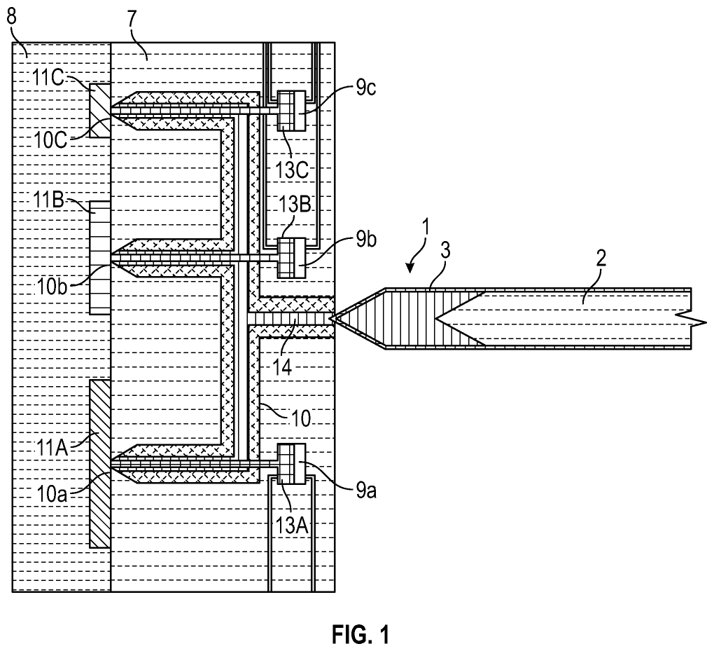

In the configuration of the injection molding machine 1 illustrated in FIG. 1, an injection unit includes an injection cylinder 3, an injection screw 2 in the injection cylinder 3, and a motor or the like (not illustrated) for rotating the injection screw 2. A fixed mold 7 is fixed to a fixed platen (not illustrated) in the injection molding machine 1. When the fixed mold 7 is combined with a movable mold 8 by a mold clamping mechanism (not illustrated), a plurality of mold cavities 11A, 11B, and 11C for receiving molten resin are formed. The movable mold 8 is movable in a direction away from the fixed mold 7 when removing a molded part.

A hot runner 10 is attached to the fixed mold 7. A resin path for supplying molten resin to each of the plurality of cavities 11A, 11B, and 11C is connected to the hot runner 10. The resin is heated to ensure the resin remains in a molten state.

Dispensers 10a, 10b, and 10c of the hot runner 10 are associated with the respective plurality of cavities 11A, 11B, and 11C. The dispensers 10a, 10b, and 10c are narrowed in a conical shape and are connected to plunger-shaped resin gate valves 13A, 13B, and 13C. The resin gate valves 13A, 13B, and 13C are connected to three sets of air cylinders 9a, 9b, and 9c respectively, which are provided in the fixed mold 7. Each of the resin gate valves 13A, 13B, and 13C, when closed, prevent resin from prematurely entering their respective associated cavities 11A, 11B, and 11C during an injection molding process as described below.

A control device (not illustrated) connected to the injection molding machine 1 provides opening/closing operation signals to a switching valve (not illustrated) of the injection molding machine 1 to control three sets of air switching valves (not illustrated). The control is based on a timing order of performing an injection process for each of the plurality of cavities 11A, 11B, and 11C. This enables providing air individually to air cylinders 9a, 9b, and 9c to open/close the resin gate valves 13A, 13B, and 13C respectively. The number of cavities are not limited to the above-described cavities. In another exemplary embodiment, a number of cavities greater than three can be provided.

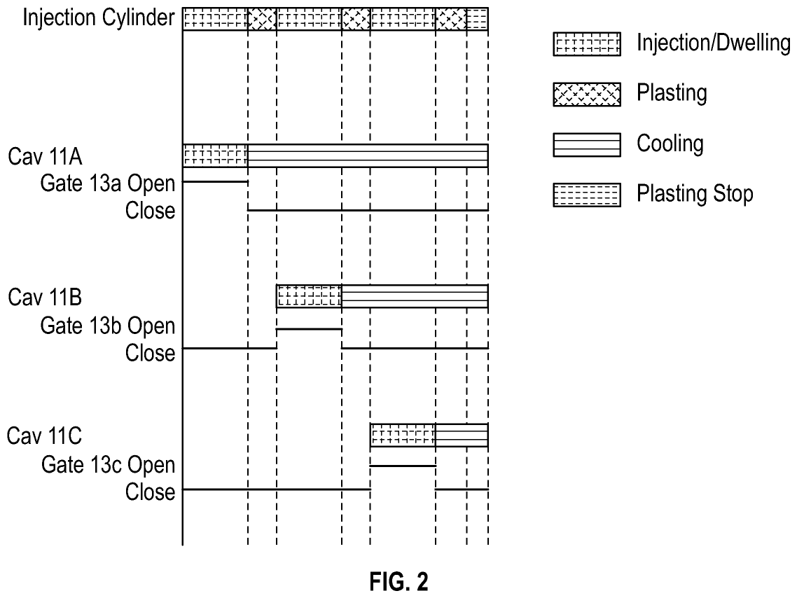

A process executed during injection molding will be described with reference to FIG. 2.

The processes in FIG. 2 are illustrated as horizontal bands, where the horizontal axis depicts time. The uppermost band illustrates the injecting filling, dwelling, and plasting process carried out by the injection cylinder 3. The band below that band illustrates the injection filling, dwelling, and cooling process of the cavity 11A. Below this band, the timing of opening and closing of the gate valve 13A associated with the cavity 11A is illustrated.

The injection filling, dwelling, and cooling process of the cavity 11B is illustrated in the next depicted band. The opening/closing timing of the gate valve 13B associated with the cavity 11B is illustrated below the illustration of the injection filling, dwelling, and cooling process of the cavity 11B. The injection, dwelling, and cooling process of the cavity 11C is illustrated in the bottom-most band. The opening/closing timing of the gate valve 13C associated with the cavity 11C is illustrated below the injection, dwelling, and cooling process of the cavity 11B.

In the injection process, injection and dwelling of molten resin is individually performed for each cavity based on a rotation speed and torque of a ball screw (not illustrated) of the injection unit. Slightly retracting the ball screw lowers the resin pressure in the injection cylinder and lets the injection screw 2 retract while it is rotating to conduct melt plasticization of the resin. A mold clamping device (not illustrated) continues to clamp the mold during the process of pressure retention and cooling. After a molded part has cooled and solidified, the mold is opened, and the molded part is removed. This completes one cycle of the injection process.

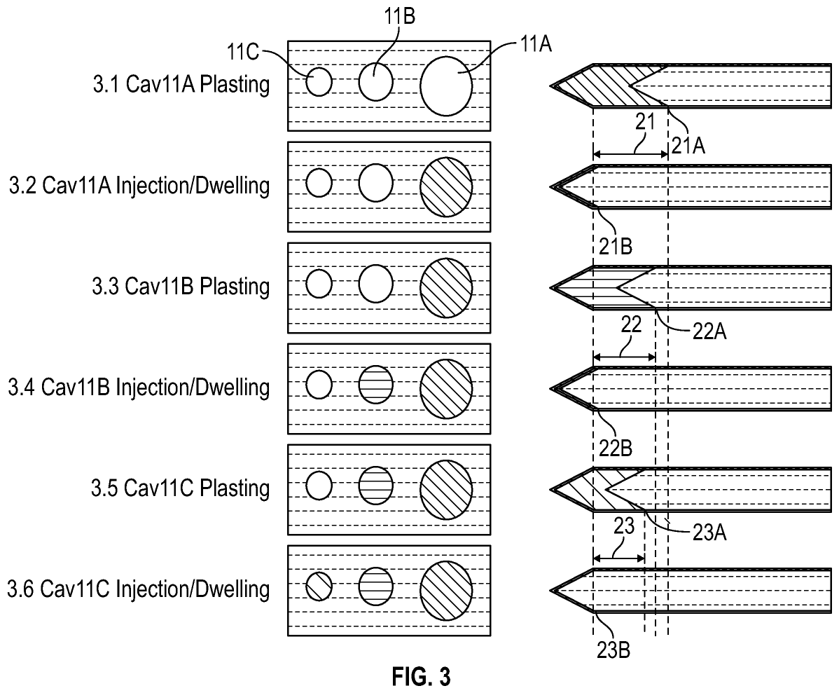

FIG. 3 illustrates an injection molding performed based on the process illustrated in FIG. 2.

As illustrated in FIG. 3, in 3.1, the amount of resin to fill the cavity 11A is measured up to a position 21A. Next, a servo motor (not illustrated) starts to rotate, the injection screw 2 is controlled at a set speed, and the injection and dwelling of the cavity 11A begins. In 3.2, the screw position when the dwelling time expires is set to 21B, and the gate valve 13A is closed. That is, after completion of the injection/dwelling of the cavity 11A, the gate valves 13A, 13B, and 13C are all temporarily closed.

After completion of the injection and dwelling of the cavity 11A, in 3.3, the amount of resin to fill the cavity 11B is measured up to a position of 22A. That is, plasting of the resin for injection into the cavity 11B is performed during the period when the gate valves 13A, 13B, and 13C are all closed. The residual pressure in the resin flow path 14 in the hot runner 10 can be released with this plasting operation.

After the plasting operation, the servo motor starts rotating, the injection screw 2 is controlled at a set speed, and the injection and dwelling of the cavity 11B starts. In 3.4, the screw position when the dwelling time expires is set to 22B, and the gate valve 13B is closed. That is, after completion of the injection/dwelling of the cavity 11B, the gate valves 13A, 13B, and 13C are all temporarily closed.

In 3.5, after the injection and dwelling of the cavity 11B is completed, the amount of resin to fill the cavity 11C it is measured up to a position of 23A. That is, plasting of the resin for injection into the cavity 11C is performed during the period when the gate valves 13A, 13B, and 13C are all closed. The residual pressure in the resin flow path 14 in the hot runner 10 can be released with this plasting operation.

After the plasting operation, the servo motor starts rotating, the injection screw 2 is controlled at a set speed, and the injection and dwelling of the cavity 11C starts. In 3.6, the screw position when the dwelling time expires is set to 23B, and the gate valve 13C is closed. That is, after completion of the injection/dwelling of the cavity 11C, the gate valves 13A, 13B, and 13C are all temporarily closed.

The above-described order enables, after phased injection and dwelling are performed in all the cavities by repeating the plasting, injection, dwelling and gate closing operations based on the molding conditions of each cavity, cooling to be performed. Since the start position of the injection screw is reset by conducting plasting each time the cavity is changed, the weight variation due to the residual pressure at the time of the previous cavity molding during the molding of the next cavity, molding failure, and the like are eliminated. The filling completion position 21B-23B can be the same position or another position.

In the above exemplary embodiment, the plasting periods are individually provided for each of the cavities 11A, 11B, and 11C, but this approach is not seen to be limiting. In another exemplary embodiment, the resin required for injection into the cavities 11A and 11B can be determined in a single plasting, while the plasting for the cavity 11C can be conducted after injection/dwelling into the cavity 11B.

In another exemplary embodiment, whether the plasting is performed individually for the cavities 11A, 11B and 11C or collectively for two or more of the cavities can be set/changed via, for example, a user operation. In this case, a limit on the timing that can be set/changed via user operation can be set such that the setting change is not made during the implementation of the injection molding process.

In the above exemplary embodiment, an example in which the cavities 11A, 11B, and 11C are injected in this order was described, but this order is not seen to be limiting. In another exemplary embodiment, for example, the cavity with the longest cooling time, from among the plurality of cavities 11A, 11B, and 11C, can be injected first. In another exemplary embodiment, the order of injection/dwelling of the plurality of cavities 11A, 11B, and 11C can also be in the order of the longer cooling time.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Combinations of any exemplary embodiments disclosed above are also included as embodiments of the present disclosure. While the above-described exemplary embodiments discuss illustrative embodiments, these embodiments are not seen to be limiting.

What is claimed is:

1. A method for performing injection molding using a mold with at least two cavities and an injection cylinder, the method comprising:
supplying resin to be injected into a first cavity, from among the at least two cavities, of the mold to the injection cylinder;
injecting the resin into the first cavity;
supplying resin to be injected into a second cavity, from among the at least two cavities, of the mold to the injection cylinder; and
injecting the resin into the second cavity,
wherein the resin injected into the first cavity is cooled,
wherein the resin injected into the second cavity is cooled, and
wherein molded parts are removed from the first cavity and from the second cavity after the resin in the first cavity has cooled and solidified and the resin in the second cavity has cooled and solidified.

2. A method according to claim 1, further comprising closing a gate valve associated with a cavity from among the at least two cavities that resin is being injected into.

3. A method according to claim 1, wherein a separate period for melting a predetermined amount of resin and filling the injection cylinder using an injection screw is provided for each of the at least two cavities.

4. A method according to claim 1, further comprising supplying resin to be injected into a third cavity, from among the at least two cavities, of the mold to the injection cylinder.

5. A method according to claim 4, wherein a first period for melting a predetermined amount of resin and filing the injection cylinder using an injection screw is provided for the first and second cavities and a second period for melting a predetermined amount of resin and filing the injection cylinder using the injection screw is provided for the third cavity.

6. A method according to claim 1, wherein a cavity with a longest cooling time from among the at least two cavities is injected first.

7. An injection molding machine for performing injection molding with a mold having at least two cavities, the injection molding machine comprising:
an injection cylinder; and
at least one controller configured to control:
supplying resin to be injected into a first cavity, from among the at least two cavities, of the mold to the injection cylinder,
injecting the resin into the first cavity,
supplying resin to be injected into a second cavity, from among the at least two cavities, of the mold to the injection cylinder, and
injecting the resin into the second cavity,
wherein the resin injected into the first cavity is cooled,
wherein the resin injected into the second cavity is cooled, and
wherein molded parts are removed from the first cavity and from the second cavity after the resin in the first cavity has cooled and solidified and the resin in the second cavity has cooled and solidified.

8. An injection molding machine according to claim 7, wherein the at least one controller is further configured to control closing a gate valve associated with a cavity from among the at least two cavities that resin is being injected into.

9. An injection molding machine according to claim 7, wherein a separate period for melting a predetermined amount of resin and filling the injection cylinder using an injection screw is provided for each of the at least two cavities.

10. An injection molding machine according to claim 7, wherein the at least one controller is further configured to control supplying resin to be injected into a third cavity, from among the at least two cavities, of the mold to the injection cylinder.

11. An injection molding machine according to claim 10, wherein a first period for melting a predetermined amount of resin and filling the injection cylinder using an injection screw is provided for the first and second cavities and a second period for melting a predetermined amount of resin and filing the injection cylinder using the injection screw is provided for the third cavity.

12. An injection molding machine according to claim 7, wherein a cavity with a longest cooling time from among the at least two cavities is injected first.

13. A method for manufacturing products by injection molding using a mold with at least two cavities and an injection cylinder, the method comprising:
supplying resin to be injected into a first cavity, from among the at least two cavities, of the mold to the injection cylinder;
injecting the resin into the first cavity;
supplying resin to be injected into a second cavity, from among the at least two cavities, of the mold to the injection cylinder; and
injecting the resin into the second cavity,
wherein the resin injected into the first cavity is cooled,
wherein the resin injected into the second cavity is cooled, and
wherein molded parts are removed from the first cavity and from the second cavity after the resin in the first cavity has cooled and solidified and the resin in the second cavity has cooled and solidified.
